(19) United States
(12) Patent Application Publication
(10) Pub. No.: US 2017/0022745 A1
(43) Pub. Date: Jan. 26, 2017

(54) CONTROL ASSEMBLY FOR AN OUTWARDLY OPENING PIVOTING WING

(71) Applicant: SAVIO S.p.A., Chiusa San Michele (Torino) (IT)

(72) Inventor: Aimone BALBO DI VINADIO, Chiusa San Michele (Torino) (IT)

(21) Appl. No.: 15/196,555

(22) Filed: Jun. 29, 2016

(30) Foreign Application Priority Data
Jul. 14, 2015 (IT) 102015000034081

(51) Int. Cl. E05F 11/34; E05C 9/06; E05F 7/08

(52) U.S. Cl. CPC E05F 11/34; E05F 7/08; E05C 9/063

(57) ABSTRACT

A control assembly for an outwardly opening pivoting wing, comprising an actuating device including a support, a crank rotatable with respect to the support and a control mechanism actuated by the crank, an arm having a toothed portion, wherein said control mechanism cooperates with the toothed portion of the arm for swinging the arm between a closed wing angular position and an open wing angular position.

### CROSS-REFERENCE TO RELATED APPLICATIONS

This application claims benefit of Italian patent application number 102015000034081, filed Jul. 14, 2015, which is herein incorporated by reference.

### BACKGROUND OF THE INVENTION

Field of the Invention

The present invention relates to accessories for doors and windows and regards a control assembly for an outwardly opening pivoting wing.

The invention can be applied to wings articulated about vertical axes or to wings articulated about horizontal axes.

Description of Prior Art

Devices are known for opening and closing an outwardly opening pivoting wing comprising:
an actuating device including a crank associated with a worm screw and a rotatable gear, driven into rotation by said worm screw; and
an arm, pivoting about a fixed pin and having a toothed portion that meshes with said gear, wherein said gear cooperates with the toothed portion to swing the arm between a closed wing angular position and an open wing angular position.

The openable wings are normally equipped with a locking device to lock the wing in the closed position. In the known solutions, the locking/unlocking device of the wing is separate and independent from the opening/closing device of the wing. The locking device can, for example, be controlled by a cremone handle or by any other known type of device. Therefore, two independent maneuvers for controlling the locking/unlocking of the wing and the opening/closing movement are necessary.

U.S. Pat. No. 2,114,645 describes a device for opening and closing a pivoting wing equipped with a crank-operated device, which also controls the locking and unlocking of the wing. The device described in U.S. Pat. No. 2,114,645 comprises:
an actuating device including a support, a crank rotatable with respect to the support and a control mechanism actuated by the crank; and
an arm having a toothed portion, which cooperates with said control mechanism, wherein the control mechanism cooperates with the toothed portion of the arm for swinging the arm between a closed wing angular position and an open wing angular position, and wherein in the closed wing angular position, the control mechanism cooperates with the toothed portion of the arm for the translational motion of the arm along a straight direction between a locked wing position and an unlocked wing position, and vice versa.

In certain applications, it is necessary to provide a device capable of limiting the opening stroke of the wing because certain regulations require that the maximum opening angle of the wing is not greater than a predetermined value. In these cases it would be necessary to provide an additional device to limit the opening stroke of the wing or modify the actuating device to ensure that the maximum opening angle is below the value fixed by the regulations. In any case, there are complications for providing a limit of the maximum value of the opening angle of the wing.

### SUMMARY OF THE INVENTION

The present invention aims to provide a device for opening and closing a pivoting wing that also controls the locking and unlocking of the wing, wherein the limitation of the maximum opening angle of the wing is possible, without complications.

According to the present invention, this object is achieved by a device having the characteristics forming the subject of claim 1.

The claims form an integral part of the disclosure provided here in relation to the invention.

### BRIEF DESCRIPTION OF THE DRAWINGS

The present invention will now be described in detail with reference to the attached drawings, given purely by way of non-limiting example, wherein:

FIG. 1 is a perspective view of a wing provided with a control assembly according to the present invention in an open position.

FIG. 2 is an exploded perspective view illustrating a control assembly according to the present invention.

FIG. 3 is a perspective view on an enlarged scale of the opening/closing device indicated by the arrow III in FIG. 2.

FIG. 4 is an exploded perspective view of the part indicated by the arrow IV in FIG. 3.

FIG. 5-FIG. 8 are plan views according to the arrow V of FIG. 3 illustrating the sequence of operation of the control assembly according to the present invention.

### DETAILED DESCRIPTION

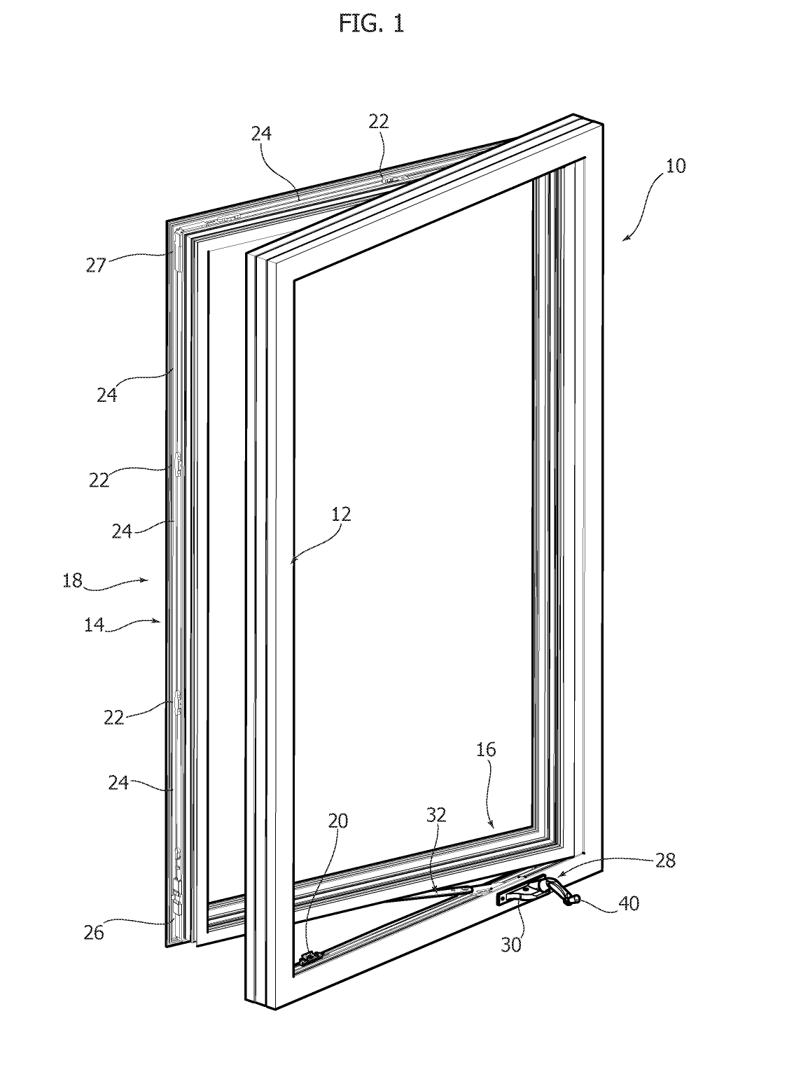

With reference to FIG. 1, numeral 10 indicates a window including a fixed frame 12 and a wing 14 articulated to the fixed frame 12 about a vertical axis and outwardly opening.

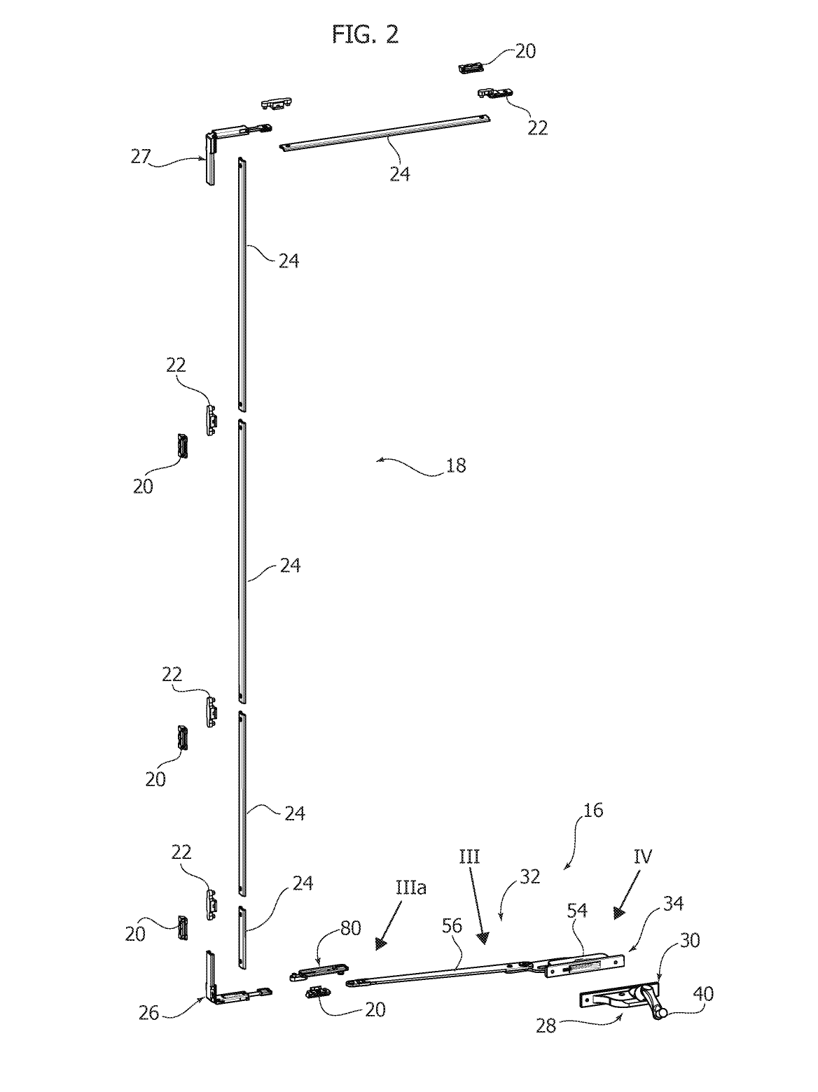

With reference to FIGS. 1 and 2, the window 10 comprises a control assembly including an opening/closing device 16 and a locking device 18. The opening/closing device 16 is intended to be mounted on the fixed frame 12, for example, on the lower horizontal side of the frame 12.

The locking device 18 comprises a plurality of strikers 20 fixed to the frame 12 along the lower horizontal side, the upper horizontal side and along the vertical side opposite to the articulation axis. The locking device 18 comprises a plurality of locking elements 22 cooperating with respective strikers 20. The locking elements 22 are carried by the wing 14 in a sliding manner in the longitudinal direction of the respective side of the wing. The locking elements 22 are preferably located on the lower horizontal side, on the upper horizontal side and the vertical side of the wing 14 opposite to the articulation axis. The locking elements 22 are movable with respect to the wing 14 between an unlocked position and a locked position. In the locked position, the locking elements 22 are facing respective strikers 20, so as to prevent opening of the wing 14. In the unlocked position, the locking elements 22 are disengaged from the strikers 20, so as not to obstruct the opening of the wing 14.

The locking elements 22 are connected together by means of connecting rods 24, which are movable with respect to the wing 14 along respective longitudinal directions. The locking device 18 further comprises a lower corner drive 26 and an upper corner drive 27, which connect together the connecting rods 24 and the locking elements 22 located along sides of the wing 14 orthogonal to each other.

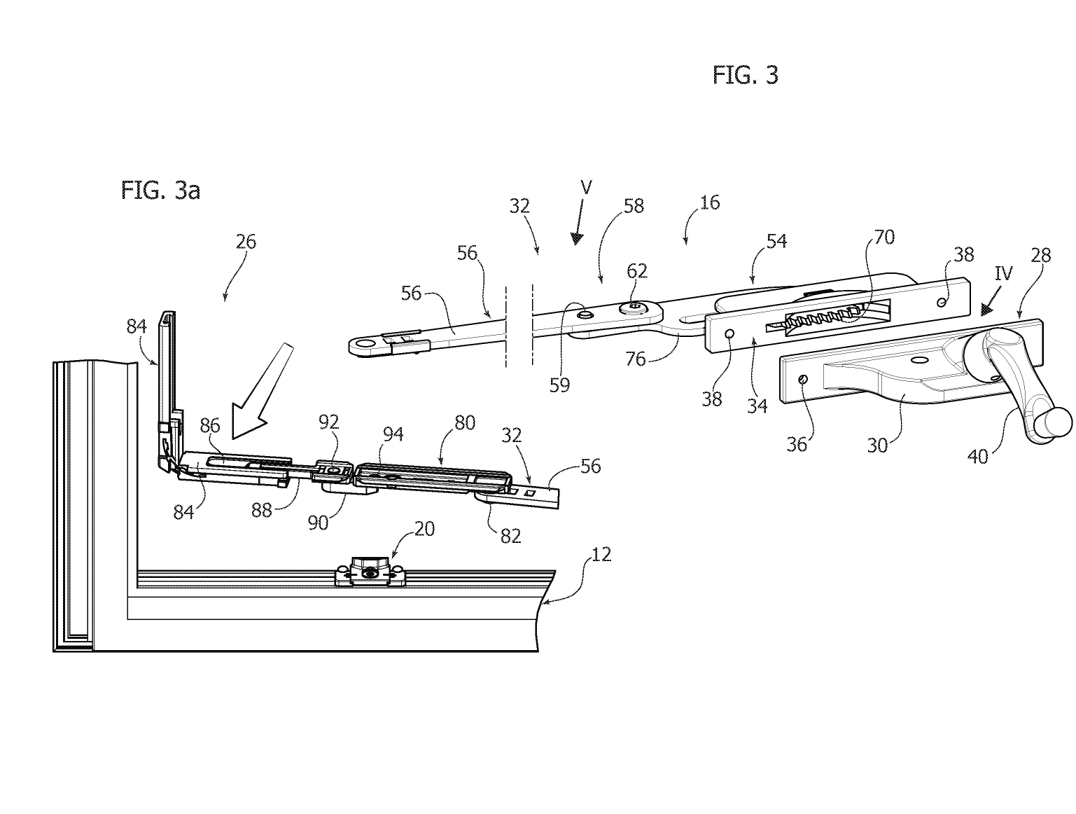

With reference to FIG. 3, the opening/closing device 16 comprises a crank-operated device 28 intended to be fixed to the fixed frame 12. The crank-operated device 28 includes a first support 30 and a second support 34. The first support 30 carries a rotatable crank 40. The second support 34 carries an arm 32, which is capable of swinging and moving with respect to the second support 34. The first and the second supports 30, 34 are intended to be fixed on opposite faces of the same wall of the fixed frame 12. The first and the second supports 30, 34 are provided with holes 36, 38 aligned with each other and designed to be engaged by fastening screws (not shown). Alternatively, a single support could be provided that carries out the function of the first and second supports 30, 34.

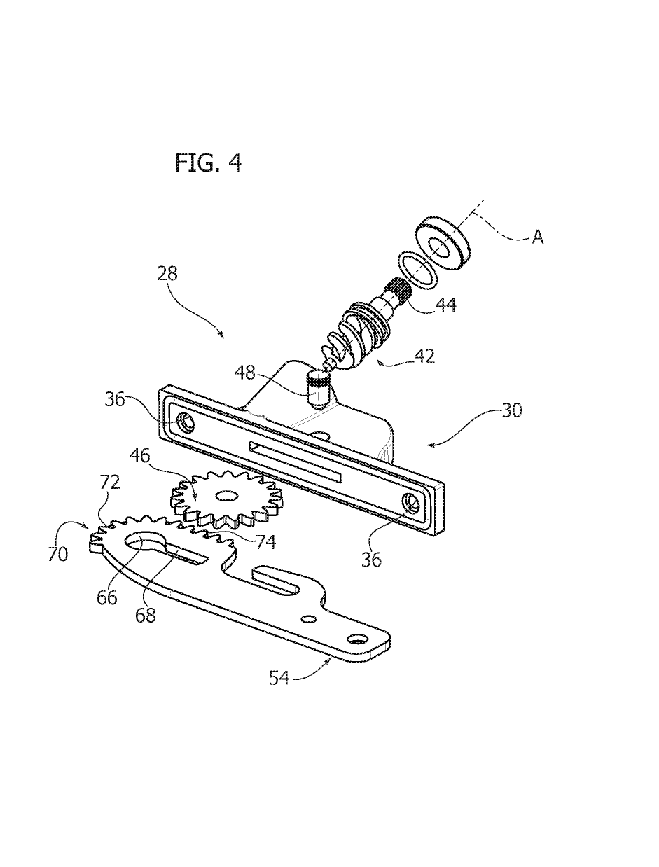

With reference to FIG. 4, the actuating device 28 comprises a worm screw 42, rotatable with respect to the first support 30 about an axis A coinciding with the rotation axis of the crank 40. The crank 40 is fixed to one end 44 of the worm screw 42. The actuating device 28 comprises a gear 46 rotatably mounted with respect to the first support 30 about a fixed pin 48. The gear 46 meshes with the worm screw 42 and is driven into rotation about the pin 48 by the crank 40.

With reference to FIG. 3, the arm 32 comprises a first arm section 54 and a second arm section 56 fixed together by means of an adjusting device 58 that allows adjustment of the angular position of the second arm portion 56 with respect to the first arm portion 54. The adjusting device 58 comprises a first pin 59, which engages two aligned holes and connects the first and the second arm portions 54, 56 together in an articulated manner. The adjusting device 58 also comprises a second pin 62, which engages a hole of the first arm section 54 in a rotatable manner. The second pin 62 has an eccentric portion, which engages a slot of the second arm section 56. An angular movement of the second pin 62 about its own axis varies the angular position of the second arm section 56 with respect to the first arm section 54. Once the adjustment is made, the two sections of the arm 54, 56 are fixed to each other in the selected position.

With reference to FIG. 4, the first arm section 54 is connected to the first support 30 by means of a mechanism that allows the arm 32 to pivot about an axis between a closed wing position and an open wing position, and vice versa, and that, in the closed position, allows the arm 32 to move in a straight direction with respect to the support 30 between a locked wing position and an unlocked wing position, and vice versa. A mechanism of this type is described in detail in the Italian patent application TO2014A000230. This mechanism comprises an articulation seat 66 formed in the first arm section 54. The articulation seat 66 has a circular profile that communicates with a straight guide 68, radial with respect to the center of the articulation seat 66. The articulation seat 66 has a circular profile, interrupted at the straight guide 68. The straight guide 68 has two straight parallel walls that define a straight opening, which leads into the articulation seat 66. The articulation seat 66 is engaged by a pin with a rectangular cross-section carried by the second support 34.

The first arm section 54 has a toothed portion 70 composed of a circular toothed portion 72 and a straight toothed portion 74. The teeth of the toothed portion 70 extend continuously and with constant pitch along the circular toothed portion 72 and along the straight toothed portion 74. In the embodiment illustrated, the circular toothed portion 72 is coaxial with the articulation seat 66 and the straight toothed portion 74 is parallel to the straight guide 68. The gear 46 meshes with the toothed portion 70 of the first arm section 54. When the gear 46 meshes with the straight toothed portion 74, the rotation of the crank 40 controls a movement in the straight direction of the arm 32. When the gear 46 meshes with the circular toothed portion 72, the rotation of the crank 40 controls a swinging of the arm 32 about a fixed axis.

With reference to FIGS. 3 and 5-8, the opening/closing device 16 comprises a slider 80, intended to be slidably mounted within a longitudinal groove of the lower horizontal side of the wing 14. The slider 80 is articulated to the distal end of the arm 32 by a pin 82.

Still with reference to FIG. 3, the corner drive 26, known per se, comprises an angular support 84, intended to be fixed at a corner of the wing 14. The angular support 84 carries a flexible lamina 86, which is movable within the two orthogonal arms of the support 84. The corner drive comprises a mobile element 88 guided with respect to the support 84 in a straight direction and fixed to the flexible lamina 86. The mobile element 88 is movable with respect to the support 84 between a position corresponding to the disengaged position of the locking elements 22 (position in which the locking elements 22 are disengaged from the respective strikers 20) and an engaged position of the locking elements 22 (position in which the locking elements 22 are engaged with the respective strikers 20). The stroke of the mobile element 88 with respect to the support 84 is limited by stroke-end means, known per se. The maximum stroke of the mobile element 88, with respect to the support, is equal to the stroke of the locking elements 22 between the disengaged position and the engaged position.

The mobile element 88 of the corner drive is fixed to the slider 80 of the opening/closing device 16. In the example illustrated in the figures, the mobile element 88 and the slider 80 are fixed together by means of a closing element 90, which is intended to cooperate with a striker 20 fixed to the frame 12. In the example illustrated, the closing element 90 forms a unique piece with the slider 80 and is fixed to the mobile element 88 by means of a pin 92. Alternatively, the slider 80 could be fixed to the mobile element 88 by means of a connecting rod 24 identical to the connecting rods that connect the closing elements 22 to each other.

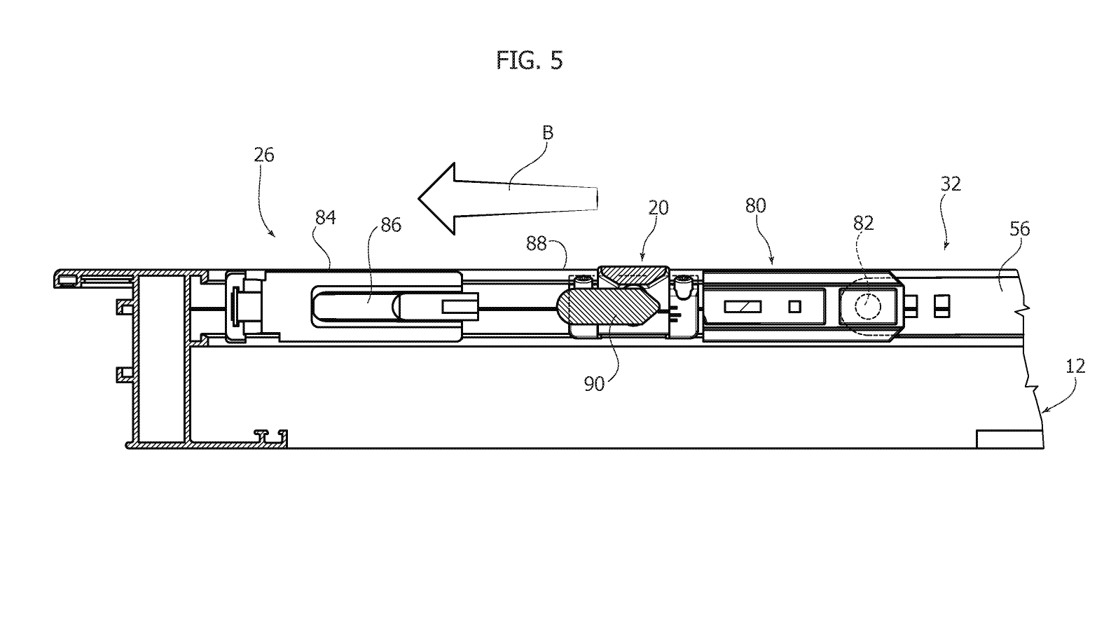

FIGS. 5-8 illustrate the operation of the opening/closing device 16.

FIG. 5 shows the closed and locked condition of the wing 14. In this condition, the locking element 90—fixed to the slider 80 and to the mobile element 88 of the corner drive 26—engages the corresponding striker 20 fixed to the frame 12. Furthermore, all the locking elements 22 distributed along three sides of the wing 14 engage the respective strikers 20 distributed along three sides of the frame 12.

In the closed and locked configuration of the wing 14, the gear 46 of the crank-operated device 28 meshes with the straight toothed portion 74 of the arm 32.

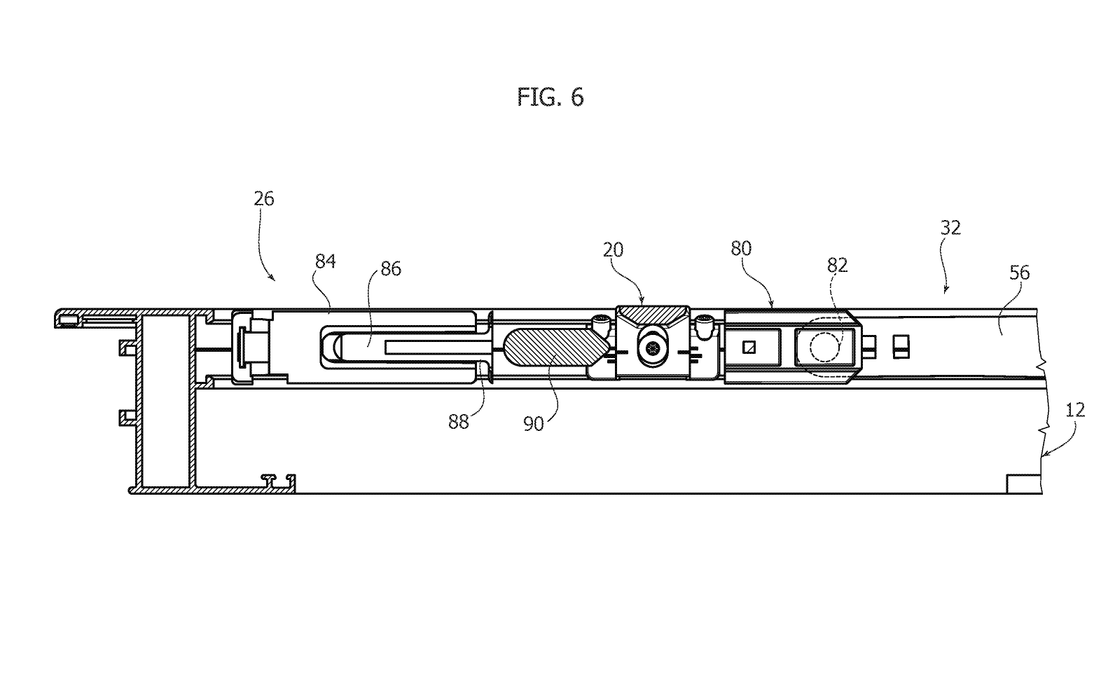

Starting from the closed and locked position, the rotation of the crank 40 controls a translation movement of the arm 32 in the straight direction B of FIG. 5 from the closed and locked wing position illustrated in FIG. 5 towards the closed and unlocked wing position illustrated in FIG. 6. The slider 80 and the mobile element 88 of the corner drive 26 move together with the arm 32 from the closed and locked wing position towards the closed and unlocked wing position.

With reference to FIG. 6, in the closed and unlocked wing position, the locking element 90 is disengaged from the respective striker 20. The corner drive 26, driven by the slider 80, moves all the locking elements 22 from the engaged position to the disengaged position.

In the closed and unlocked wing position, the gear 46 meshes with the circular toothed portion of the gear teeth 72 of the arm 32.

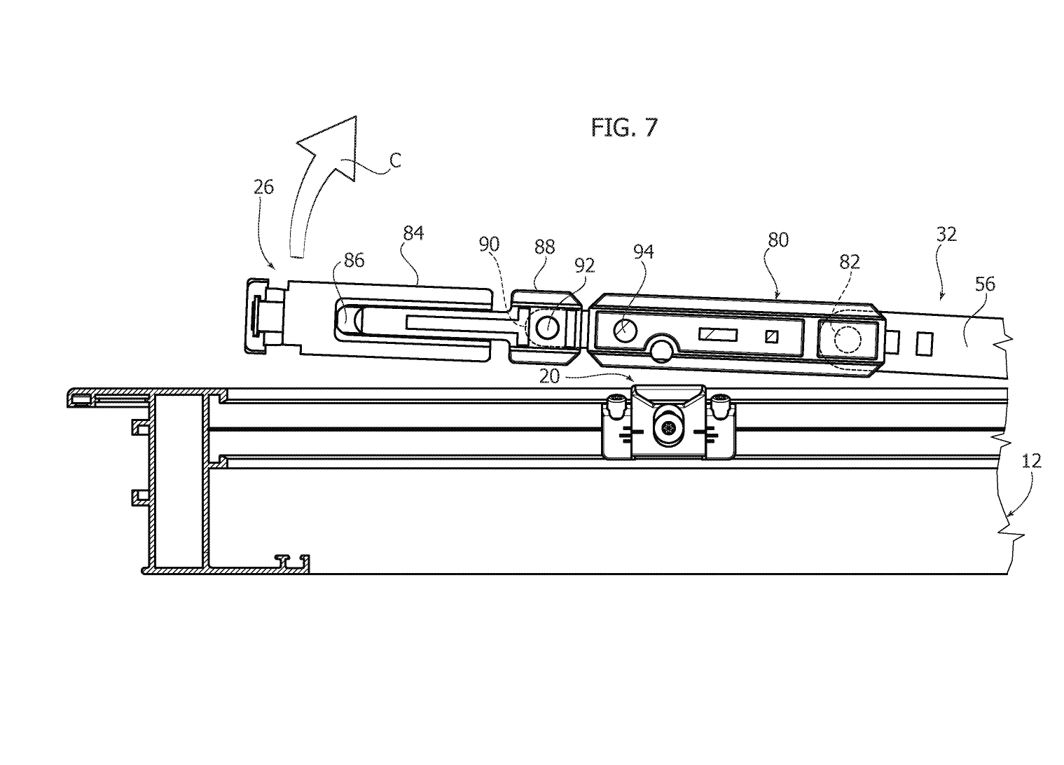

Continuing to rotate the crank 40, the arm 32 swings from the closed position towards the open position in the direction indicated by arrow C in FIG. 7.

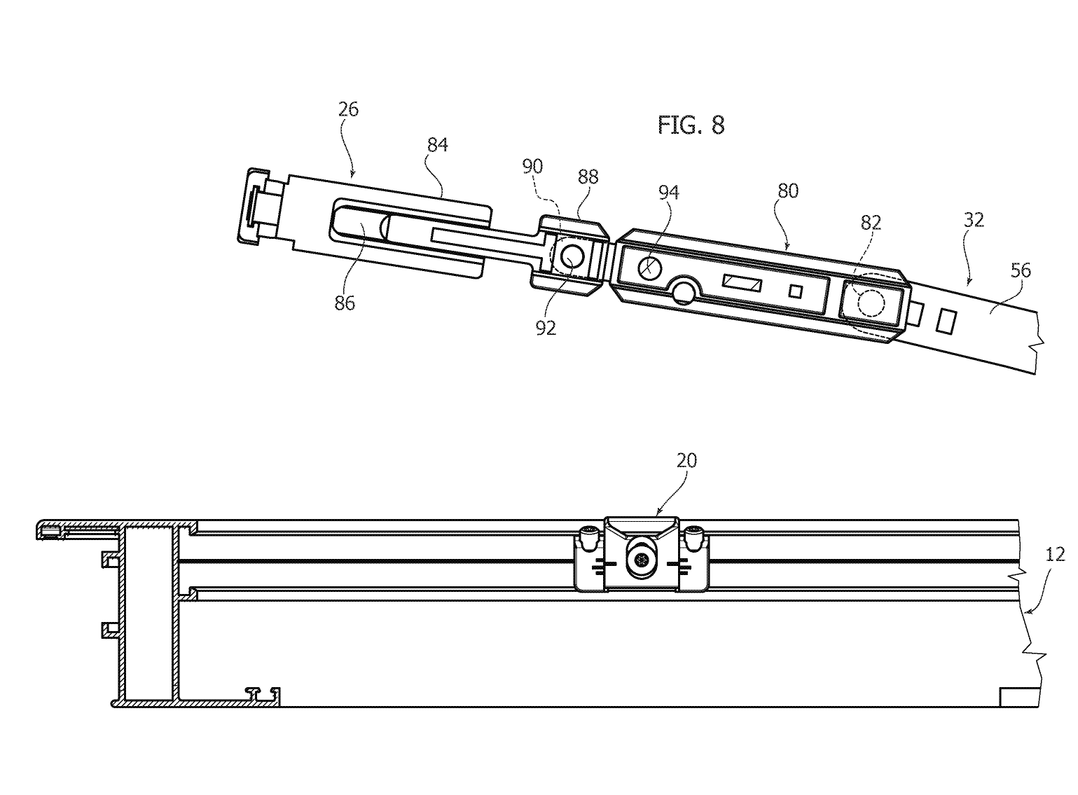

The swinging of the arm 32 in the direction C opens the wing 14. During the opening movement of the wing 14, the mobile element 88 of the corner drive moves with respect to the support 84 until it reaches a stroke-end position, as shown in FIG. 8. This position is the maximum opening position of the wing 14. A further rotation of the crank 40 is prevented by the stroke-end of the corner drive 26, which prevents a further movement of the mobile element 88. Therefore, the fixing between the slider 80 and the mobile element 88 of the corner drive limits the maximum opening of the wing 14 to a predetermined angle, which depends on the maximum stroke of the mobile element 88 and the width of the wing 14. Therefore, in cases where the regulations envisage that the outwardly openable wings have a predetermined maximum opening angle, with the system according to the present invention, an intrinsic limitation of the maximum opening angle is obtained without the need to provide an independent opening limiter.

During the closing movement of the wing 14, the previously described steps are followed in the opposite direction.

Of course, without prejudice to the principle of the invention, the details of construction and the embodiments can be widely varied with respect to those described and illustrated, without thereby departing from the scope of the invention as defined by the claims that follow.

1. A control assembly for an outwardly opening pivoting wing, comprising:
an actuating device including a support, a crank rotatable with respect to the support and a control mechanism actuated by the crank;
an arm having a toothed portion, wherein said control mechanism cooperates with the toothed portion of the arm for swinging the arm between a closed wing angular position and an open wing angular position, and wherein in the closed wing angular position, the control mechanism cooperates with the toothed portion of the arm for the translational motion of the arm along a straight direction between a locked wing position and an unlocked wing position; and vice versa
a locking device comprising a plurality of locking elements intended to be mounted on the wing, a plurality of connecting rods that connect said locking elements to each other, and at least one corner drive intended to be mounted in a corner of said wing and comprising an angular support, a flexible lamina movable along said angular support and a mobile element attached to said flexible lamina, and a slider articulated to a distal end of said arm and intended to engage the wing in a movable manner in a straight direction, wherein said slider is fixed to said mobile element of said corner drive.

2. A control assembly according to claim 1, wherein said slider and said mobile element are fixed together by means of a locking element intended to cooperate with a respective striker.

3. A control assembly according to claim 2, wherein said locking element is fixed to said mobile element by a pin.

4. A control assembly according to claim 1, wherein said slider and said mobile element are fixed to each other by means of a connecting rod.
